(19) United States
(12) Patent Application Publication
(10) Pub. No.: US 2013/0304280 A1
(43) Pub. Date: Nov. 14, 2013

(54) VEHICLE CONTROL AND DISPLAY SYSTEM

(71) Applicants: Michael Tai-Hao Wen, Taipei (TW); Jerry Lin, Taipei (TW); Cheng Ta Lin, Taipei (TW)

(72) Inventors: Michael Tai-Hao Wen, Taipei (TW); Jerry Lin, Taipei (TW); Cheng Ta Lin, Taipei (TW)

(21) Appl. No.: 13/470,654

(22) Filed: May 14, 2012

(51) Int. Cl. G06F 17/00

(52) U.S. Cl. 701/2

(57) ABSTRACT

A vehicle control and display system to control the vehicle systems and display vehicle information. A control processing unit communicates with remote units and the vehicle systems wherein when the control processing unit receives commands from the remote units, the control processing unit transfers these commands to the vehicle systems. The vehicle information is displayed on the control processing unit or on the remote units. The control processing unit receives vehicle information from the vehicle systems and transfers that information to remote units to be displayed.

### BACKGROUND OF THE INVENTION

1. Field of the Invention

The invention relates to a system to control vehicle equipment and display vehicle information on a control unit and on remote units.

2. Description of the Related Art

Vehicle equipment can be controlled and vehicle information can be displayed in many different ways. For example to control car radio, the driver or the passenger can use buttons on the radio. Likewise control buttons on a DVD device can be used to control it or a separate controller for DVD device can be used. Each of these devices may have their own remote controllers. If the driver or the passenger wants to control these devices they can either use individual remote controls or use the buttons on these devices. For example, the driver would have to use windshield viper controls located somewhere close to the driver seat. To place car into a cruise control mode where the speed is automatically adjusted, driver would normally use a cruise control button located close to where the driver seat is.

Vehicle information such as speed, rotation per minute information for the engine, oil pressure, engine temperature and other vehicle information are usually displayed on a dashboard.

These systems mentioned above do not enable the driver or the passenger to easily control vehicle systems and monitor vehicle information.

### SUMMARY OF THE INVENTION

The invention solves the shortcomings of the current art mentioned above.

One object of the present invention is to provide a vehicle display system where the vehicle information can be displayed on at least one remote unit that can be seen by driver and others in the car.

Another object of the present invention is to provide a system where at least one remote unit can be used to control vehicle systems.

Another object of the present invention is to provide a system where any device that is capable of wireless communication can be used to control vehicle systems and display vehicle information.

Another object of the present invention is to provide a system with plurality of remote units where remote units can be controlled from the control processing unit such that video displayed on one remote unit can be viewed either on the control processing unit or on other remote units.

Another object of the present invention is to provide a system with plurality of remote units where remote units can be controlled from the control processing unit such that audio played on one remote unit can be listened either on the control processing unit or on other remote units.

The present invention may be fully understood from the description of preferred embodiments of the invention set forth below, together with the accompanying drawings.

### BRIEF DESCRIPTION OF THE DRAWINGS

FIG. 1 shows the perspective view of the controller box;

FIG. 2 shows the first embodiment of the technical solution;

FIG. 3 shows the second embodiment of the technical solution;

FIG. 4 shows a typical display screen of vehicle information;

FIG. 5 shows the algorithm used by the controller box;

FIG. 6 shows the algorithm used by the remote unit.

### DETAILED DESCRIPTION OF THE INVENTION

Referring to the drawings, preferred embodiments of the present invention are described below. The present invention provides a vehicle control and display system as described below.

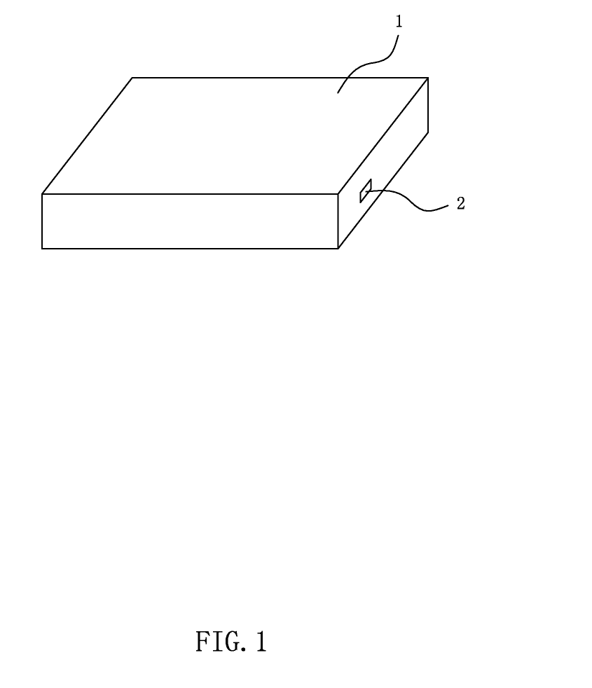

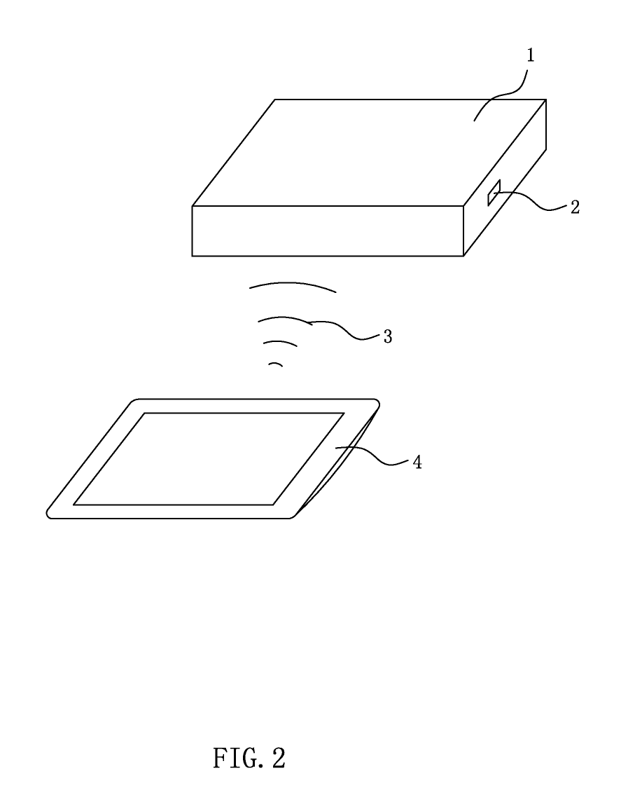

In FIG. 1, the control processing unit 1 is shown. The control processing unit 1 may have a wireless connection or may have a wired connection that connects to the outside of the box by using the connector 2. The control processing unit 1 may have both wireless and wired connections. The control processing unit 1 may or may not have a display unit. In either case, the control processing unit 1 may have buttons to control the control processing unit 1 or it may have a touch screen on the control processing unit's 1 display to control the control processing unit 1. The control processing unit 1 is a device that communicates with remote unit 4 (shown in FIG. 2) entering into the car. Once the communication is established, the control processing unit 1 sends the vehicle information to remote unit 4. There may be only one remote unit 4 or there may be plurality of remote units 4. If there are multiple remote units 1, the same vehicle information can be displayed on all remote units. Alternatively, each remote unit 4 sends a request message to the control processing unit 1. As a result of this request message, the control processing unit 1 sends to that particular remote unit only the information requested in the request message that comes from that particular remote unit 4. The control processing unit 1 also receives setting commands from at least one remote unit 4 and communicates with vehicle systems to carry out those commands coming from at least one remote unit 4. There may be multiple remote units 4 in which case the control processing unit 1 will establish communication with all remote units 4 and the control processing unit 1 will transfer those commands from plurality of remote units 4 to vehicle control systems. The control processing unit 1 has an electronics circuit in it and a program that controls the operation of it.

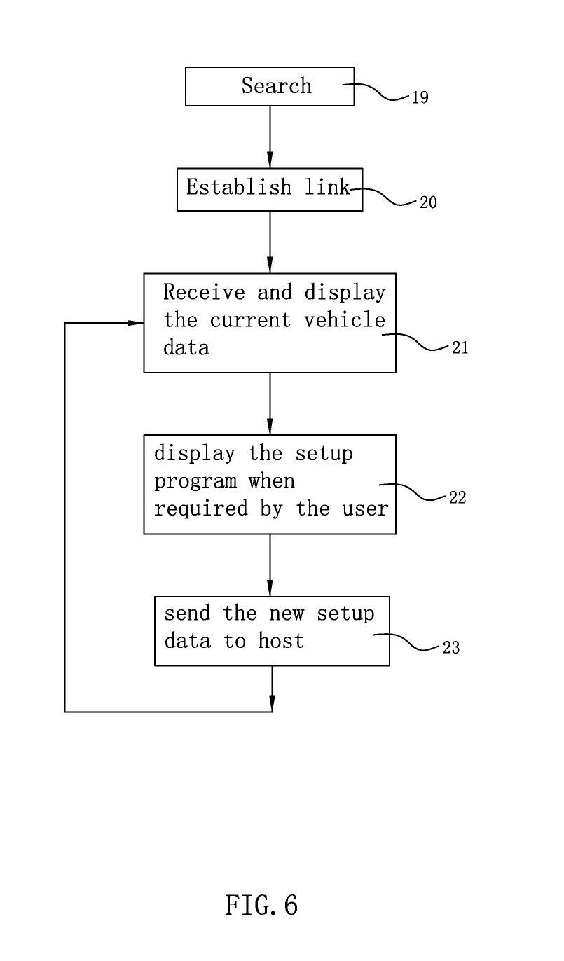

In FIG. 2, the control processing unit 1 and the remote unit 4 are shown. In this embodiment, the control processing unit 1 and the remote unit 4 use wireless communication link 3. The wireless communication link 3 can be 802.11, RF communication, bluetooth or any other proprietary wireless communication. The remote unit 4 can be a unit available in the market such as smartphone or a tablet or any other generic device where an algorithm can be placed inside the unit during the manufacturing process. This is called, embedded program in the generic remote unit. When the embedded program in the generic remote unit is activated, the program performs the operations that are listed in FIG. 6. The remote unit 4 may also be specially designed unit. Specially designed unit means the unit is specifically designed for the vehicle control system disclosed in this invention. Although FIG. 2 shows a single remote unit 4, there may be multiple remote units 4.

Each remote unit 4 may have the capability of displaying vehicle information and sending set up commands to the control processing unit 1. Alternatively, certain remote units 4 may be used to display vehicle information only while other remote units 4 are used to send set up information to the control processing unit 1. In this set up a user that has a remote unit 4 that has the display capability only will be able to monitor vehicle information but will not be able to send set up commands to the control processing unit 1. A person that has a remote unit 4 with setup capability only will be able to send vehicle set up information to the control processing unit 1 however the user will not be able to see the vehicle information on that remote unit 4. A person that has a remote unit 4 with both display and set up capabilities will be able to monitor vehicle information on that remote unit 4 while also be able to send vehicle set up information to the control processing unit 1 by using that remote unit 4.

Each remote unit 4 may send a request message to control processing unit 1 listing the vehicle information that should be displayed on that remote unit 4. The control processing unit 1 upon receiving that request, sends the requested vehicle information to the remote unit 4 to be displayed on the remote unit 4. A user can select which vehicle information to be displayed on each remote unit 4. Alternatively, each remote unit 4 may have a fixed algorithm with the vehicle information to be displayed in which case a user cannot select which vehicle information to be displayed on that remote unit 4.

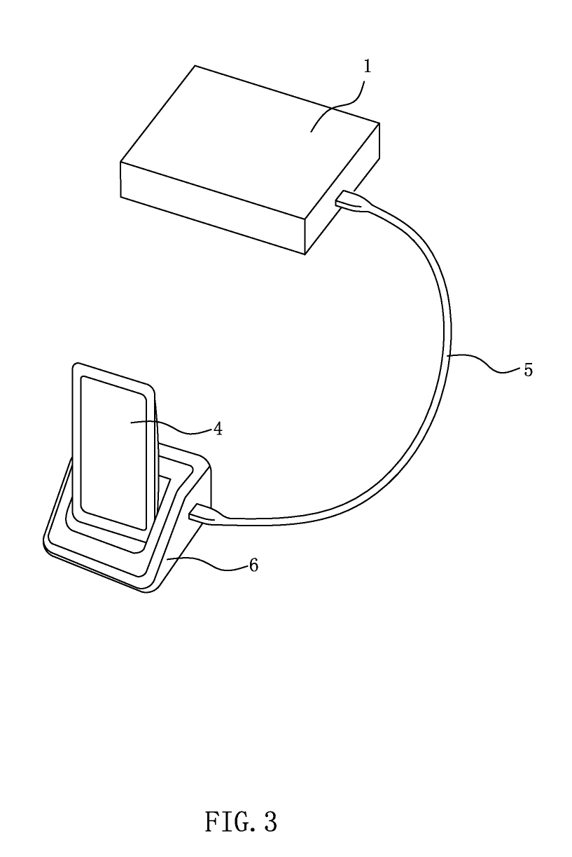

FIG. 3. Shows another embodiment of the invention. In FIG. 3, the control processing unit 1 and the remote unit 4 are connected by cable 5 using a docking device 6. The docking device 6 can be either fixed to a location in the car or can be moved to different locations in the vehicle. A connector in the docking device 6 matches the connector on the remote unit 4. This way when remote unit 4 is placed in the docking device 6, connectors match and as a result, the remote unit 4 can be connected to the control processing unit 1 via the cable 5. The docking device 6 can be a wireless device in which case there will be no cable 5 between the docking device 6 and the control processing unit 1. In this embodiment, the remote unit 4 will communicate with the docking device 6 and then the docking device 6 communicates with the control processing unit 1.

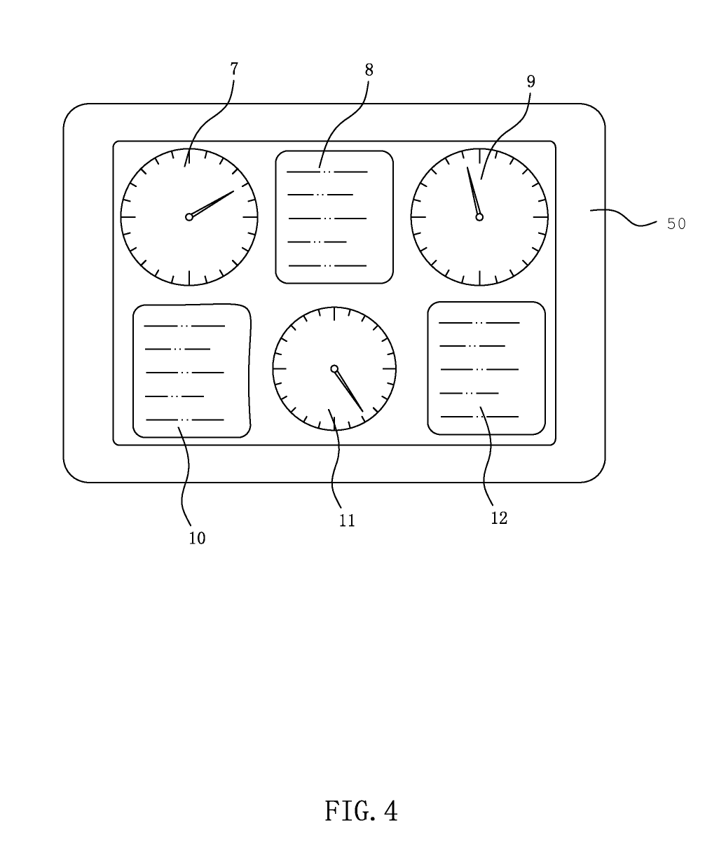

In FIG. 4, a typical vehicle display is shown. The speed indicator 7, the oil indicator 9, the return per minute indicator 11 and other information all displayed in the display system 50. This display system is usually placed on the dashboard. In this invention the display information 7, 8, 9, 10, 11 and 12 are displayed on the remote unit 4 (shown in FIG. 2 and FIG. 3).

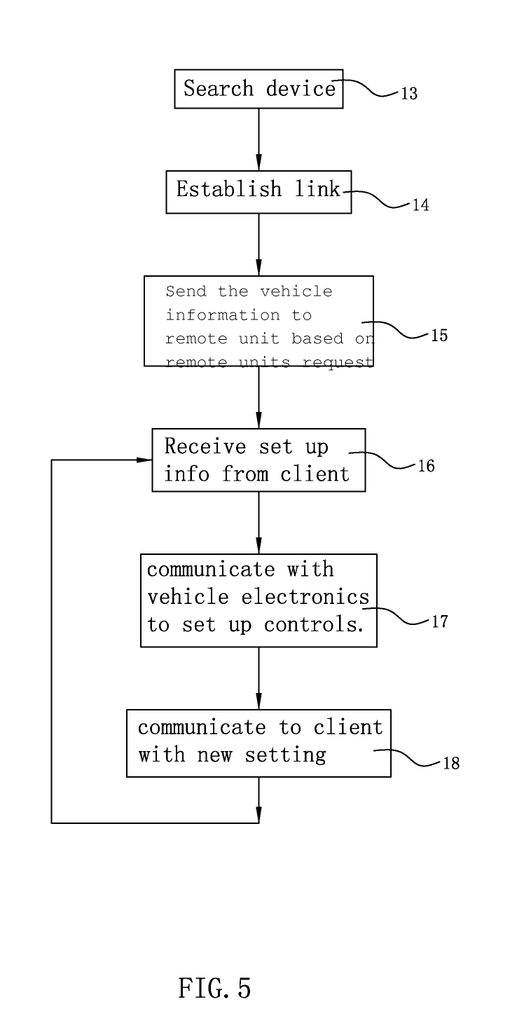

In FIG. 5, the algorithm used in the control processing unit 1 shown. The device uses an operating system such as Android or any other operating system. A program that utilizes the algorithm runs on the control processing unit 1. In this algorithm, in step 13 the control processing unit 1 first performs a search for the remote unit 4. Once the control processing unit 1 detects a remote unit 4 and it establishes a link of communication between the control processing unit 1 and a remote unit 4. This is accomplished in step 14. In step 15, the control processing unit 1 sends the vehicle information to the remote unit 4. The control processing unit 1 sends only the information requested by the remote unit 1. If the remote unit 1 does not send any special request to the control unit 1 then the control unit 1 sends all available vehicle information to the remote unit 4. If the remote unit 4 sends a special request to the control unit 1, then the control unit 1 sends only the vehicle information requested by the remote unit 4. In step 16, the control processing unit 1 receives the set up data from the remote unit 4. In step 17 the control processing unit 1 sends the set up information to vehicle systems. The vehicle system include speed system, vehicle windshield vipers; vehicle radio; vehicle digital player; vehicle back windows vipers; vehicle map system; vehicle brake system; vehicle mirrors; vehicle heater; headlights control; chair massage control; seat temperature control system; seat position control system; turn signals control system; rear view camera system; front camera system; side view camera system and vehicle air conditioner. The vehicle system may include other systems that may not be mentioned here. In step 18 the control processing unit 1 sends the new settings information. The steps searching device 13, establishing link 14, sending the current vehicle information to portable device 15 can be implemented as a display algorithm. The steps searching device 13, establishing link 14, receiving setup info from client 16, communicating with vehicle electronics to set up controls 17 and communicating to client with new setting 18 can be implemented together. Alternatively all steps mentioned in this embodiment can be implemented in sequence described above.

In FIG. 6, the algorithm used within the remote unit 4 is shown. The device uses an operating system such as Android or any other operating system. A program that utilizes the algorithm runs on the remote unit 4. In this algorithm, in step 19 the remote unit 4 searches for the control processing unit 1. Once the control processing unit 1 is discovered a communication link between the control processing unit 1 and the remote unit 4 is established in step 20. In step 21, the remote unit 4 receives the data from the control processing unit 1. Also in step 21, the data received from the control processing unit 1 by the remote unit 4 is displayed on the remote unit 4. In step 22, when the end user inputs information and set up data in to the remote unit 4 this set up data is displayed on the remote unit 4. In step 23, the remote unit 4 sends the set up information to the control processing unit 1. The link established in step 20 is used for this purpose.

In another embodiment of the invention, the remote unit 4 is capable of sending its screen information to the control processing unit 1. The communication between the control processing unit 1 and the remote unit 4 can either be wireless or with wired connection. In this set up, a user is enabled to control the remote unit 4 by using the control processing unit's 1 touch display screen. A user can still control the remote unit 4 by using remote unit 4 input. If a video is being played on the remote unit 4, others will be able to watch the same video on the control processing unit's 1 display screen or on another remote unit 4. Alternatively, a video is being played on the remote unit 4, can be displayed on the control processing unit 1 and on another remote unit 4. If an audio is being played on the remote unit 4, others will be able to listen to the audio on the car's stereo system.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention.

I claim:

1. A vehicle control and monitoring system comprising: a control processing unit; a remote unit; wherein commands from the remote unit is communicated to the control processing unit; and wherein the control processing unit communicates with at least one vehicle system to control the vehicle systems based on the commands it receives from the remote unit.

2. The vehicle control and monitoring system as in claim 1 wherein the remote unit is capable of displaying information conveyed to the remote unit by the control processing unit.

3. The vehicle control and monitoring system as in claim 1 wherein the connection between the control processing unit and the remote unit is a wired connection.

4. The vehicle control and monitoring system as in claim 1 wherein the connection between the control processing unit and the remote unit is a wireless connection.

5. The vehicle control and monitoring system as in claim 1 wherein the control processing unit is connected to at least one vehicle control system to control its operation.

6. The vehicle control and monitoring system as in claim 1 wherein the control processing unit is capable of sending vehicle information to remote unit to get displayed on the remote unit.

7. The vehicle control and monitoring system as in claim 1 wherein the remote unit has a display unit to display vehicle information.

8. The vehicle control and monitoring system as in claim 1 wherein the control processing unit uses a method to communicate with at least a remote unit and with at least one vehicle control system, the method comprising the steps of: searching for the remote unit; establishing a link between the control processing unit and the remote unit; and sending the vehicle information to the remote unit.

9. The vehicle control and monitoring system as in claim 1 wherein the control processing unit uses a method to communicate with at least a remote unit and with at least a vehicle control system, the method comprising the steps of: searching for the remote unit; establishing a link between the control processing unit and the remote unit; receiving vehicle device set up information from the remote unit; communicating vehicle set up information with at least a vehicle control unit; and updating the remote unit with new settings of at least a vehicle unit.

10. The method of claim 8 wherein the remote unit is automatically identified by the control processing unit based on a database of device identifications kept in the control processing unit.

11. The method of claim 9 wherein the remote unit is automatically identified by the control processing unit based on a database of device identifications kept in the control processing unit.

12. The vehicle control and monitoring system as in claim 1 wherein the remote unit uses a method to communicate with the control processing unit the method comprising the steps of: establishing a communication link with the control processing unit; receiving the current vehicle information from the control processing unit; and displaying the current vehicle information.

13. The vehicle control and monitoring system as in claim 1 wherein the remote unit uses a method to communicate with the control processing unit the method comprising the steps of: establishing a communication link with the control processing unit; registering a set up information entered by the user; and communicating the set up information to the control processing unit.

14. The vehicle control and monitoring system as in claim 1 wherein the plurality of vehicle control systems comprise: speed system, vehicle windshield vipers; vehicle radio; vehicle digital player; vehicle back windows vipers; vehicle map system; vehicle brake system; vehicle mirrors; vehicle heater; headlights control; chair massage control; seat temperature control system; seat position control system; turn signals control system; rear view camera system; front camera system; side view camera system and vehicle air conditioner.

15. The vehicle control and monitoring system as in claim 1 wherein the remote unit is a specially designed unit.

16. The vehicle control and monitoring system as in claim 1 wherein the remote unit is any smartphone or tablet device that has the capability of communicating with the control processing unit either by an embedded application or upon adding an application program to it.

17. The vehicle control and monitoring system as in claim 1 further comprising a docking station wherein the remote unit can be connected to.

18. The vehicle control and display system as in claim 17 wherein the docking station is connected to the control processing unit by wires and is capable of communicating with the remote unit.

19. The vehicle control and display system as in claim 17 wherein the docking station is connected to the control processing unit by wireless connection and is capable of communicating with the control processing unit.

20. The vehicle control and display system as in claim 17 wherein the remote unit has no direct communication link with the control processing unit and the remote unit communicates with the docking station.

21. The vehicle control and display system as in claim 1 wherein the control processing unit has an operating system to control the operation of the control processing unit.

22. The vehicle control and display system as in claim 1 wherein the remote unit has an operating system to control the operation of the remote unit.

23. The vehicle control and display system as in claim 21 wherein the operating system is Android operating system.

24. The vehicle control and display system as in claim 22 wherein the operating system is Android operating system.

25. The vehicle control and display system as in claim 1 wherein the algorithm to control the remote unit from the control processing unit comprises the steps of: transferring the remote unit's display information to the control processing unit; displaying the remote unit's display information on the control processing unit's display; entering commands using the displayed information on the control processing unit to control the operation of the remote unit; and sending the information entered into the control processing unit to remote unit.

26. The method of claim 25 wherein commands are entered into the control processing unit by using control buttons.

27. The method of claim 25 wherein commands are entered into the control processing unit by using a touch control screen placed on the control processing unit's display.
